(19) United States
(12) Patent Application Publication
(10) Pub. No.: US 2021/0403772 A1
(43) Pub. Date: Dec. 30, 2021

(54) CURABLE ADHESIVE COMPOSITION

(71) Applicant: BASF SE, Ludwigshafen am Rhein (DE)

(72) Inventors: Randall J. PETRIE, Charlotte, NC (US); Shuk-Kwan Jackie MURPHY, Charlotte, NC (US); Kevin PAYNE, Wyandotte, MI (US); Armin A. BURGHART, Charlotte, NC (US)

(21) Appl. No.: 17/294,611

(22) PCT Filed: Nov. 18, 2019
(86) PCT No.: PCT/US2019/061976

§ 371 Date: May 17, 2021

Related U.S. Application Data
(60) Provisional application No. 62/768,664, filed on Nov. 16, 2018.

(51) Int. Cl. C09J 133/06; C08F 220/12; C08F 230/08; C09J 143/04

(52) U.S. Cl. CPC C09J 133/064; C08F 220/12; C08F 2800/20; C09J 143/04; C08F 230/085

(57) ABSTRACT

Compositions comprising a copolymer, an inorganic filler, and a moisture cure catalyst are described herein. In some instances, the copolymer can be derived from a (meth)acrylate, a carboxylic acid anhydride, and an aminosilane, wherein the aminosilane can be pendant from the copolymer backbone. In other instances, the copolymer can be derived from a (meth)acrylate and an organosilane in the absence of a chain transfer agent at a temperature of at least 150° C. Methods of making and using the compositions are further described. In some examples, the compositions are adhesive compositions and can be used in adhering two substrates, such as in floor covering.

### FIELD OF THE DISCLOSURE

The present disclosure relates to curable compositions, particularly to curable compositions including a silane-modified (meth)acrylic copolymer.

### BACKGROUND

Curable polymers such as polyurethanes are used in a variety of applications. For example, adhesives based on urethane chemistry have been used for many years. Urethane-based adhesives are derived from isocyanates and generally involve the use of volatile organic solvents in the formulation process. Isocyanates are hazardous chemicals, and a portion of the isocyanates are undesirably present after polymerization. Further, volatile organic solvents are environmentally unfriendly and, when present in the final adhesive product, may cause a noxious odor. Urethane-based adhesive compositions are also difficult to clean up. For example, it can be difficult to remove wet urethane-based adhesives from floor articles with a cloth or rag. It is often necessary to utilize hazardous chemicals or tools to remove the cured adhesive. The use of such harsh chemicals or tools to remove urethane-based adhesives can alter the aesthetic appearance of articles or even result in irreparable damage to the article.

Water-based adhesives have also been proposed for use in adhesives. These purported benign adhesives, however, can cause water damage to substrates such as wood.

It is desirable to minimize the use of hazardous chemicals in the preparation of adhesives. It is also desirable to provide compositions that are easily cleaned from articles without causing damage or compromising the aesthetic finish of the articles. The compositions and methods described herein address these and other needs.

### SUMMARY OF THE DISCLOSURE

Disclosed herein are compositions comprising a copolymer, an inorganic filler, and a moisture cure catalyst. The compositions can have a Brookfield viscosity of 10,000 cps or greater, 15,000 cps or greater, 25,000 cps or greater, from 10,000 cps to 100,000 cps, from 10,000 cps to 50,000 cps, or from 25,000 cps to 60,000 cps, determined at 25° C. and 20 rpm using a #7 spindle, and a solids weight % of greater than 50%, 80% or greater, from 50% to 99%, or from 80% to 99%. The compositions can comprise less than 0.1% by weight water, preferably less than 0.05% by weight water, more preferably are anhydrous. In some examples, the compositions are adhesive compositions. The compositions, e.g., the adhesive compositions, are preferably free of isocyanates.

The copolymer in the compositions can be derived from one or more (meth)acrylates and one or more carboxylic acid anhydrides. In these embodiments, the compositions can further include one or more aminosilanes, an inorganic filler present in an amount of at least 5% by weight, based on the total weight of the composition, and a moisture cure catalyst. In some instances, at least a portion of the one or more aminosilanes can react with the one or more carboxylic acid anhydrides in the copolymer backbone. In other embodiments, the copolymer in the compositions can be derived from monomers including one or more (meth)acrylates and one or more organosilanes in the absence of a chain transfer agent at a temperature of at least 150° C. In these embodiments, the compositions can further include an adhesion enhancer, an inorganic filler present in an amount of at least 5% by weight, based on the total weight of the composition, and a moisture cure catalyst. The copolymer can be present in an amount of from 10-95% by weight, based on the total weight of the composition.

The one or more carboxylic acid anhydrides present in the copolymer can be selected from the group consisting of (meth)acrylic anhydride, itaconic anhydride, citraconic anhydride, maleic anhydride, and combinations thereof. The copolymer can be derived from greater than 0% to 15% by weight, preferably from 1% to 10% by weight, more preferably from 1% to 5% by weight, of the one or more carboxylic acid anhydrides, based on the total weight of monomers in the copolymer.

The one or more (meth)acrylates in the copolymer can be selected from the group consisting of butyl acrylate, ethyl acrylate, 2-ethylhexyl acrylate, and combinations thereof. The copolymer can be derived from 60% to 95%, preferably from 75% to 95%, by weight of the one or more (meth)acrylates, based on the total weight of monomers in the copolymer.

The one or more organosilanes in the copolymer can include a vinyl silane such as, vinyltrimethoxysilane, vinyltriethoxysilane, vinyl tris(2-methoxyethoxysilane), vinyl triisopropoxysilane, gamma-methacryloxypropyl trimethoxysilane, (3-methacryloxypropyl)-trimethoxysilane, (3-methacryloxypropyl)-triethoxysilane, (3-methacryloxypropyl)-triisopropoxysilane, 2-methyl-2-propenoic acid 3-[tris-(1-methylethoxy)-silyl]-propyl ester, (3-methacryloxypropyl)-methyldiethoxysilane, 3-glycidoxypropyl methyldiethoxysilane, 3-glycidoxypropyl methyldimethoxysilane, or combinations thereof. The copolymer can be derived from greater than 0% to 15% by weight, preferably from 1% to 10% by weight, more preferably from 1% to 5% by weight, of the one or more organosilanes, based on the total weight of monomers in the copolymer.

The copolymer can further comprise one or more additional monomers selected from ethylenically unsaturated carboxylic acid monomers, (meth)acrylamide, styrene, hydroxyethylacrylate, or combinations thereof.

As described herein, the one or more aminosilanes present can react with the one or more carboxylic acid anhydrides in the copolymer, thus forming a group pendant to the copolymer backbone. In some embodiments, the one or more aminosilanes can react with monomers in the copolymer and form a portion of the copolymer backbone. In some embodiments, the one or more aminosilanes can have structures represented by general Formula I:

H₂N—(R¹)—Si(R²)₃ Formula I

wherein R¹ and R² are independently, for each occurrence, selected from a C₁-C₁₀ alkyl group, a C₂-C₁₀ alkenyl group, a C₁-C₁₀ alkoxy group, a C₁-C₁₀ alkylthio group, or a C₁-C₁₀ alkylamino group. For example, the one or more aminosilanes can be selected from 3-aminopropylmethyldiethoxysilane, 3-aminopropyltrimethoxysilane, 3-aminopropyltriethoxysilane, N-(2-aminoethyl-3-aminopropyl)-trimethoxysilane, or combinations thereof. The compositions can be derived from greater than 0% to 10% by weight, preferably from 1% to 5% by weight, of the one or more aminosilanes, based on the total weight of the composition.

The copolymer present in the composition can have a measured T_{g} of 25° C. or less, preferably from −60° C. to 25° C., more preferably from −60° C. to 10° C., and most preferably from −60° C. to less than 0° C. The copolymer can have a weight average molecular weight of from 1,000 Daltons to 15,000 Daltons and preferably from 4,000 Daltons to 13,000 Daltons. The copolymer can be present in an amount of from greater than 10% to 95% by weight, preferably from 40% to 90% by weight, more preferably from 50% to 90% by weight, of the composition.

In addition to the copolymer, the composition can further comprise an adhesion enhancer, an inorganic filler, and a moisture cure catalyst. The adhesion enhancer can include a vinyl organosilane, an aminosilane, an epoxysilane, or a combination thereof. The adhesion enhancer can be present in an amount of from 0.05% to 10% by weight, based on the total weight of the composition.

The inorganic filler present in the composition can include a pigment selected from calcium carbonate, titanium dioxide, kaolin, bentonite, mica, talc, attapulgite, or zeolite. The inorganic filler can be present in an amount of from 30% to 80%, preferably from 55% to 75% by weight, based on the total weight of the composition.

The moisture cure catalyst can include a metal carboxylate. In some embodiments, the composition is free of a tin-containing catalyst.

The composition may further comprise a film-forming aid, a defoamer, a thickener, a tackifier, a water scavenger, or a combination thereof. In some examples, the composition comprises a water scavenger.

Adhesive compositions comprising the copolymers disclosed herein can exhibit a load at break of 80 lb_{f} or greater, preferably 90 lb_{f} or greater, and more preferably 100 lb_{f} or greater for a vinyl to cement board having a contact area of 1″×2″, determined by a lap shear test after 24 hours of standing at 23° C. and 50% relative humidity. In some embodiments, the adhesive compositions disclosed herein can exhibit a load at break of 130 lb_{f} or greater, preferably 150 lb_{f} or greater, and more preferably 170 lb_{f} or greater for a hardwood to cement board having a contact area of 1″×2″, determined by a lap shear test after 24 hours of standing at 23° C. and 50% relative humidity. The adhesive compositions can exhibit a 90° peel strength after 24 hours of contact time for vinyl to cement board having a contact area of 2″×6″ of 18 lb_{f} or greater, preferably 20 lb_{f} or greater, more preferably 22 lb_{f} or greater. In some embodiments, the adhesive compositions can exhibit a 90° peel strength after 7 days of contact time for hardwood to cement board having a contact area of 2″×6″ of 115 lb_{f} or greater, preferably 120 lb_{f} or greater.

Floor articles comprising the compositions are also disclosed herein.

Methods of making and using the compositions are further disclosed. In some embodiments, the method can include mixing a copolymer produced by solution polymerization and derived from one or more (meth)acrylates and one or more carboxylic acid anhydrides with one or more aminosilanes, an inorganic filler, and a moisture cure catalyst to form the composition. The one or more aminosilanes can be mixed with the copolymer derived from the one or more (meth)acrylates and the one or more carboxylic acid anhydrides after solution polymerization. For example, the one or more aminosilanes can be mixed directly with the copolymer after polymerization or added as a package with, for example, the inorganic filler and/or the moisture cure catalyst. In other embodiments, the method of making the composition can include mixing a copolymer produced by solution polymerization and derived from monomers including one or more (meth)acrylates and one or more organosilanes, wherein the copolymer is derived at a temperature of at least 150° C., with an inorganic filler, an adhesion enhancer, and a moisture cure catalyst to form the composition. Preferably, the copolymers are produced in the absence of a chain transfer agent.

The methods of making the compositions can further include a step of adding a plasticizer, a stabilizer, an antioxidant, a film forming aid, or a water scavenger to the composition. As described herein, the copolymers are produced in the absence of water. Preferably, the compositions are anhydrous.

The compositions can be used to adhere two surfaces comprising applying the composition disclosed herein to at least a first surface, adhering a second surface to the first surface, and allowing the composition to cure. In some embodiments, the compositions can be dry to the touch in less than 4 hours, preferably less than 2 hours.

The details of one or more embodiments are set forth in the description below. Other features, objects, and advantages will be apparent from the description and from the claims.

### DETAILED DESCRIPTION

The compositions and methods described herein may be understood more readily by reference to the following detailed description of specific aspects of the disclosed subject matter and the examples included therein.

Before the present compositions and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

In this specification and in the claims that follow, reference will be made to a number of terms, which shall be defined to have the following meanings.

Throughout the description and claims of this specification, the words “comprise,” “include,” and other forms of these words, such as “comprising,” “comprises,” “including,” and “includes” are open, non-limiting terms and do not exclude additional elements such as, for example, additional additives, components, integers, or steps. Although the terms “comprising” and “including” have been used herein to describe various embodiments, the terms “consisting essentially of” and “consisting of” can be used in place of “comprising” and “including” to provide for more specific embodiments and are also disclosed.

As used in the description and the appended claims, the singular forms “a,” “an,” and “the” include plural referents unless the context clearly dictates otherwise. Thus, for example, reference to “a composition” includes two or more compositions, reference to “an adhesion enhancer” includes two or more adhesion enhancers, reference to “the catalyst” includes two or more catalysts, and the like.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

The percent by weight recited herein are based on the total weight of a composition including solvent, unless indicated otherwise.

As used herein, “(meth)acryl . . . ” includes acryl . . . and methacryl . . . and also includes diacryl . . . , dimethacryl . . . and polyacryl . . . and polymethacryl . . . . For example, the term “(meth)acrylate monomer” includes acrylate and methacrylate monomers, diacrylate and dimethacrylate monomers, and other polyacrylate and polymethacrylate monomers.

The term “(co)polymer” includes homopolymers, copolymers, or mixtures thereof.

Described herein are compositions comprising a copolymer, an inorganic filler, and a moisture cure catalyst.

Copolymer

Compositions comprising a copolymer, an inorganic filler, and a moisture cure catalyst are provided herein. In some examples, the compositions can include a copolymer derived from one or more (meth)acrylates and one or more carboxylic acid anhydrides. In these embodiments, the compositions can further comprise one or more aminosilanes added to the compositions after polymerization of the copolymer. In some embodiments, at least a portion of the one or more aminosilanes can be incorporated (grafted) onto the copolymer as a group pendant from the copolymer backbone.

In some examples, the copolymer can be derived from monomers including one or more (meth)acrylates and one or more organosilanes. In these examples, at least a portion of the one or more organosilanes can be incorporated into the copolymer backbone.

The term “(meth)acrylate monomer” as used herein includes acrylate, methacrylate, diacrylate, and dimethacrylate monomers. The (meth)acrylate monomer can include esters of α,β-monoethylenically unsaturated monocarboxylic and dicarboxylic acids having 3 to 6 carbon atoms with alkanols having 1 to 20 carbon atoms (e.g., esters of acrylic acid, methacrylic acid, maleic acid, fumaric acid, or itaconic acid, with C₁-C₂₀, C₄-C₂₀, C₁-C₁₆, or C₄-C₁₆ alkanols).

One or more of the (meth)acrylate monomers when homopolymerized can have a measured T_{g} of −30° C. or less, as measured using differential scanning calorimetry (DSC) using the mid-point temperature using the method described, for example, in ASTM 3418/82. Examples of (meth)acrylate monomers having a measured T_{g} of −30° C. or less include, but are not limited to, n-butyl (meth)acrylate, 2-ethylhexyl (meth)acrylate, ethyl (meth)acrylate, isobutyl (meth)acrylate, tert-butyl (meth)acrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, heptadecyl (meth)acrylate, allyl (meth)acrylate, tetrahydrofurfuryl (meth)acrylate, cyclohexyl (meth)acrylate, 2-propylheptyl (meth)acrylate, behenyl (meth)acrylate, cyclohexyl methacrylate, t-butyl acrylate, t-butyl methacrylate, stearyl methacrylate, behenyl methacrylate, allyl methacrylate, ethyldiglycol acrylate, iso-4-hydroxylbutyl acrylate, hydroxyethylcaprolactone acrylate, 2-ethoxyethyl acrylate, 2-methoxyethyl acrylate, and combinations thereof. In some examples, the (meth)acrylate monomer comprises butyl (meth)acrylate, ethyl (meth)acrylate, 2-ethylhexyl (meth)acrylate, or a combination thereof. For example, the (meth)acrylate monomer comprises butyl acrylate, ethyl acrylate, 2-ethylhexyl acrylate, or a combination thereof.

The copolymer can, for example, be derived from 45% or more by weight of the (meth)acrylate monomer, (e.g., 50% or more, 55% or more, 60% or more, 65% or more, 70% or more, 75% or more, 80% or more, 85% or more, 90% or more, or 95% or more), based on the total monomer content. In some examples, the copolymer can be derived form 95% or less by weight of the (meth)acrylate monomer, (e.g., 90% or less, 85% or less, 80% or less, 75% or less, 70% or less, 65% or less, 60% or less, 55% or less, or 50% or less), based on the total monomer weight. The amount of the (meth)acrylate monomer in the copolymer can range from any of the minimum values described above to any of the maximum values described above. For example, the copolymer can be derived from 45% to 95% by weight of the (meth)acrylate monomer, (e.g., from 50% to 95%, from 60% to 95%, from 75% to 95%, or from 75% to 90%), based on the total monomer content.

As disclosed herein, the copolymer can be derived from a carboxylic acid anhydride. The carboxylic acid anhydride generally has ethylenic unsaturation and can, for example, be derived from a monocarboxylic acid, a dicarboxylic acid, or a combination thereof. Examples of suitable carboxylic anhydrides include, but are not limited to, (meth)acrylic anhydride, maleic anhydride, itaconic anhydride, citraconic anhydride, and combinations thereof. In some examples, the carboxylic acid anhydride can be selected from the group consisting of itaconic anhydride, maleic anhydride, and combinations thereof. In some examples, the carboxylic acid anhydride includes maleic anhydride.

The copolymer can, for example, be derived from greater than 0% by weight of the carboxylic acid anhydride, based on the total monomer weight (e.g., 0.1% or more, 0.25% or more, 0.5% or more, 0.75% or more, 1% or more, 1.5% or more, 2% or more, 2.5% or more, 3% or more, 3.5% or more, 4% or more, 4.5% or more, 5% or more, 6% or more, 7% or more, or 8% or more). In some examples, the copolymer can be derived from 15% or less by weight of the carboxylic acid anhydride, based on the total monomer weight (e.g., 12% or less, 10% or less, 9% or less, 8% or less, 7% or less, 6% or less, 5% or less, 4.5% or less, 4% or less, 3.5% or less, 3% or less, 2.5% or less, 2% or less, 1.5% or less, 1% or less, 0.75% or less, or 0.5% or less). The amount of carboxylic acid anhydride the copolymer is derived from can range from any of the minimum values described above to any of the maximum values described above. For example, the copolymer can be derived from greater than 0% to 15% by weight carboxylic acid anhydride, based on the total monomer weight (e.g., from greater than 0% to 10%, from 1% to 10%, from 1% to 8%, from 1.5% to 10%, from 1.5% to 6%, or from 1.5% to 5%).

As disclosed herein, the copolymer can be derived from an organosilane. The organosilane can be represented by the formula (R¹)—(Si)—(OR²)₃, wherein R¹ and R² are independently for each occurrence, selected from a C₁-C₁₀ alkyl group, a C₂-C₁₀ alkenyl group, a C₁-C₁₀ alkoxy group, a C₁-C₁₀ alkylthio group, or a C₁-C₁₀ alkylamino group. In some embodiments, R¹ is a C₁-C₈ substituted or unsubstituted alkyl, a C₂-C₈ substituted or unsubstituted alkenyl, a C₁-C₁₀ alkoxy group, or a C₁-C₁₀ alkylamino group; and R², which can be the same or different, each is a C₁-C₈ substituted or unsubstituted alkyl group. In some examples, the organosilane comprises a vinyl silane. Exemplary organosilanes can include vinyltrimethoxysilane, vinyltriethoxysilane, vinyl tris(2-methoxyethoxysilane), vinyl triisopropoxysilane, (meth)acryloyloxypropyl trimethoxysilane, γ-(meth)acryloxypropyl trimethoxysilane, γ-(meth)acryloxypropyl triethoxysilane, (3-methacryloxypropyl)-trimethoxysilane, (3-methacryloxypropyl)-triethoxysilane, (3-methacryloxypropyl)-triisopropoxysilane, 2-methyl-2-propenoic acid 3-[tris-(1-methylethoxy)-silyl]-propyl ester, (3-methacryloxypropyl)-methyldiethoxysilane, 3-glycidoxypropyl methyldiethoxysilane, 3-glycidoxypropyl methyldimethoxysilane, or a mixture thereof. In some examples, the organosilane comprises vinyltrimethoxysilane, vinyltriethoxysilane, vinyl tris(2-methoxyethoxysilane), vinyl triisopropoxysilane, gamma-methacryloxypropyltrimethoxy silane, or combinations thereof. For example, the organosilane can comprise vinyltriethoxysilane. In some examples, the organosilane consists of vinylethoxysilane.

The copolymer can, for example, be derived from greater than 0% such as 0.05% or more by weight of the organosilane, based on the total monomer weight (e.g., 0.1% or more, 0.2% or more, 0.3% or more, 0.4% or more, 0.5% or more, 0.6% or more, 0.7% or more, 0.8% or more, 0.9% or more, 1% or more, 1.1% or more, 1.2% or more, 1.3% or more, 1.4% or more, 1.5% or more, 1.8% or more, 2% or more, 2.5% or more, 3% or more, 3.5% or more, 4% or more, 4.5% or more, or 5% or more). In some examples, the copolymer can be derived from 15% or less by weight of the organosilane, based on the total monomer content (e.g., 13% or less, 12% or less, 10% or less, 9% or less, 8% or less, 7% or less, 6% or less, 5.5% or less, 5% or less, 4.5% or less, 4% or less, 3.5% or less, 3% or less, 2.5% or less, 2% or less, or 1.5% or less). The amount of organosilane the copolymer is derived from can range from any of the minimum values described above to any of the maximum values described above. For example, the copolymer can be derived from greater than 0% to 15% by weight of the organosilane such as from 1% to 15% by weight of the organosilane, based on the total monomer weight (e.g., from 1% to 10%, from 1.5% to 8%, or from 1.5% to 5%).

In some embodiments, the composition can include an aminosilane. The aminosilane can be represented by the formula H₂N—R¹—Si(R²)₃, wherein R¹ and R² are independently, for each occurrence, selected from a C₁-C₁₀ alkyl group, a C₂-C₁₀ alkenyl group, a C₁-C₁₀ alkoxy group, a C₁-C₁₀ alkylthio group, and a C₁-C₁₀ alkylamino group. Exemplary aminosilanes can include 3-aminopropylmethyldiethoxysilane, 3-aminopropyltrimethoxysilane, 3-aminopropyltriethoxysilane, N-(2-aminoethyl-3-aminopropyl)-trimethoxysilane or combinations thereof.

As described herein, a portion of the one or more aminosilanes present can be present as a pendant group on the copolymer backbone. For example, the one or more aminosilanes react with monomers present in the copolymer backbone to form a pendant group. In these examples, the one or more aminosilanes can react with the carboxylic acid anhydride monomers present in the copolymer backbone post polymerization. In further examples, a portion of the one or more aminosilanes can be present in the composition but do not covalently bind to the copolymer.

The compositions described herein can, for example, include from greater than 0% such as 0.05% or more by weight of the one or more aminosilanes (including aminosilanes covalently bonded to as well as not bonded to the copolymer), based on the total weight of the composition. For example, the composition can include 0.1% or more, 0.2% or more, 0.3% or more, 0.4% or more, 0.5% or more, 0.6% or more, 0.7% or more, 0.8% or more, 0.9% or more, 1% or more, 1.1% or more, 1.2% or more, 1.3% or more, 1.4% or more, 1.5% or more, 1.8% or more, 2% or more, 2.5% or more, 3% or more, 3.5% or more, 4% or more, 4.5% or more, or 5% or more aminosilane, based on the total weight of the composition. In some examples, the composition can include 15% or less by weight of the aminosilane, based on the total weight (e.g., 14% or less, 12% or less, 10% or less, 9% or less, 8% or less, 7% or less, 6% or less, 5.5% or less, 5% or less, 4.5% or less, 4% or less, 3.5% or less, 3% or less, 2.5% or less, 2% or less, 1.5% or less, 1% or less, or 0.5% or less). The amount of the one or more aminosilanes in the composition can range from any of the minimum values described above to any of the maximum values described above. For example, the composition can include from greater than 0% to 15% by weight of the one or more aminosilanes, based on the total weight (e.g., from 0.05% to 15%, from 1% to 12%, from 1% to 10%, from 1.5% to 8%, from 1.5% to 6%, or from 1.5% to 4%).

In some embodiments, the copolymer can include further monomers such as a multivinyl siloxane oligomer. Multivinyl siloxane oligomers are described in U.S. Pat. No. 8,906,997, which is hereby incorporated by reference in its entirety. The multivinyl siloxane oligomer can include oligomers having a Si—O—Si backbone. For example, the multivinyl siloxane oligomer can have a structure represented by the formula

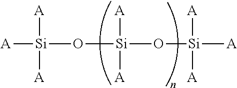

wherein each of the A groups are independently selected from hydrogen, hydroxy, alkoxy, substituted or unsubstituted C₁₋₄ alkyl, or substituted or unsubstituted C₂₋₄ alkenyl and n is an integer from 1 to 50 (e.g., 10). As used herein, the terms “alkyl” and “alkenyl” include straight- and branched-chain monovalent substituents. Examples include methyl, ethyl, propyl, butyl, isobutyl, vinyl, allyl, and the like. The term “alkoxy” includes alkyl groups attached to the molecule through an oxygen atom. Examples include methoxy, ethoxy, and isopropoxy.

In some embodiments, at least one of the A groups in the repeating portion of multivinyl siloxane are vinyl groups. The presence of multiple vinyl groups in the multivinyl siloxane oligomers enables the oligomer molecules to act as crosslinkers in compositions comprising the copolymers. In some examples, the multivinyl siloxane oligomer can have the following structure represented by the formula:

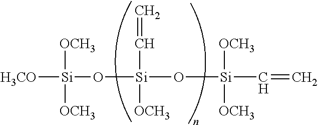

wherein n is an integer from 1 to 50 (e.g., 10). Further examples of suitable multivinyl siloxane oligomers include DYNASYLAN 6490, a multivinyl siloxane oligomer derived from vinyltrimethoxysilane, and DYNASYLAN 6498, a multivinyl siloxane oligomer derived from vinyltriethoxysilane, both commercially available from Evonik Degussa GmbH (Essen, Germany). Other suitable multivinyl siloxane oligomers include VMM-010, a vinylmethoxysiloxane homopolymer, and VEE-005, a vinylethoxysiloxane homopolymer, both commercially available from Gelest, Inc. (Morrisville, Pa.).

The copolymers can be further derived from an acid monomer. The acid monomer can include a carboxylic acid-containing monomer. Examples of carboxylic acid-containing monomers include α,β-monoethylenically unsaturated mono- and dicarboxylic acids. In some embodiments, the one or more carboxylic acid-containing monomers can be selected from the group consisting of acrylic acid, methacrylic acid, itaconic acid, maleic acid, fumaric acid, crotonic acid, dimethacrylic acid, ethylacrylic acid, allylacetic acid, vinylacetic acid, mesaconic acid, methylenemalonic acid, styrene carboxylic acid, citraconic acid, and combinations thereof.

The copolymer can be derived from 10% or less (e.g., 9% or less, 8% or less, 7% or less, 6% or less, 5% or less, 4.5% or less, 4% or less, 3.5% or less, 3% or less, 2.5% or less, 2% or less, 1.5% or less, or 1% or less) by weight of acid-containing monomers, based on the total weight of monomers from which the copolymer is derived. In some embodiments, the copolymer can be derived from 0% or greater (e.g., 0.1% or greater, 0.3% or greater, 0.5% or greater, or 1% or greater) by weight of acid-containing monomers, based on the total weight of monomers from which the copolymer is derived. In certain embodiments, the copolymer can be derived from 0% to 5% by weight, from 0.1% to 4% by weight, from 0.5% by weight to 4% by weight or from 0.5% by weight to 3.5% by weight of one or more acid-containing monomers, based on the total weight of monomers from which the copolymer is derived.

The copolymer can be derived from other monomers. For example, the copolymer can be derived from vinyl aromatic monomers, vinyl esters of branched monocarboxylic acids having a total of 2 to 12 carbon atoms in the acid residue moiety and 4 to 14 total carbon atoms such as, vinyl acetate, vinyl 2-ethylhexanoate, vinyl neo-nonanoate, vinyl neo-decanoate, vinyl neo-undecanoate, vinyl neo-dodecanoate and mixtures thereof, diene monomer such as 1,2-butadiene, 1,3-butadiene, 2-methyl-1,3-butadiene, 2-chloro-1,3-butadiene, and isoprene) and copolymerizable surfactant monomers (e.g., those sold under the trademark ADEKA REASOAP).

Suitable vinyl aromatic monomers for use in the copolymers can include styrene or an alkyl styrene such as α- and p-methylstyrene, α-butylstyrene, p-n-butylstyrene, p-n-decylstyrene, vinyltoluene, and combinations thereof. The vinyl aromatic monomer can be present in an amount of 0% by weight or greater (e.g., 1% by weight or greater, 2% by weight or greater, 5% by weight or greater, 10% by weight or greater, 15% by weight or greater, 20% by weight or greater, or 25% by weight or greater), based on the total weight of monomers from which the copolymer is derived. In some embodiments, vinyl aromatic monomer can be present in the copolymer in an amount of 50% by weight or less (e.g., 45% by weight or less, 40% by weight or less, 35% by weight or less, 30% by weight or less, 25% by weight or less, 15% by weight or less, or 10% by weight or less) based on the total weight of monomers from which the copolymer is derived. The copolymer can be derived from any of the minimum values to any of the maximum values by weight described above of the vinyl aromatic monomer. For example, the copolymer can be derived from 0% to 50% by weight (e.g., from 0% to 45%, from 2% to 40%, from 5% to 35%, from 0% to 15%, from 0% to 10%, from 2% to 10%, or from 0% to 5% by weight of vinyl aromatic monomer), based on the total weight of monomers from which the copolymer is derived.

In some embodiments, the copolymer includes a (meth)acrylamide or a derivative thereof. The (meth)acrylamide derivative include, for example, keto-containing amide functional monomers defined by the general Formula VI below

CH₂═CR₁C(O)NR₂C(O)R₃ (VI)

wherein R₁ is hydrogen or methyl; R₂ is hydrogen, a C₁-C₄ alkyl group, or a phenyl group; and R₃ is hydrogen, a C₁-C₄ alkyl group, or a phenyl group. For example, the (meth)acrylamide derivative can be diacetone acrylamide (DAAM). Suitable acetoacetoxy monomers that can be included in the copolymer include acetoacetoxyalkyl (meth)acrylates, such as acetoacetoxyethyl (meth)acrylate (AAEM), acetoacetoxypropyl (meth)acrylate, acetoacetoxybutyl (meth)acrylate, and 2,3-di(acetoacetoxy)propyl (meth)acrylate; allyl acetoacetate; vinyl acetoacetate; and combinations thereof. Sulfur-containing monomers that can be included in the copolymer including, for example, sulfonic acids and sulfonates, such as vinylsulfonic acid, 2-sulfoethyl methacrylate, sodium styrenesulfonate, 2-sulfoxyethyl methacrylate, vinyl butylsulfonate, sulfones such as vinylsulfone, sulfoxides such as vinylsulfoxide, and sulfides such as 1-(2-hydroxyethylthio) butadiene. Examples of suitable phosphorus-containing monomers that can be included in the copolymer include dihydrogen phosphate esters of alcohols in which the alcohol contains a polymerizable vinyl or olefenic group, allyl phosphate, phosphoalkyl(meth)acrylates such as 2-phosphoethyl(meth)acrylate (PEM), 2-phosphopropyl(meth)acrylate, 3-phosphopropyl (meth)acrylate, and phosphobutyl(meth)acrylate, 3-phospho-2-hydroxypropyl(meth)acrylate, mono- or di-phosphates of bis(hydroxymethyl) fumarate or itaconate; phosphates of hydroxyalkyl(meth)acrylate, 2-hydroxyethyl(meth)acrylate, 3-hydroxypropyl(meth)acrylate, ethylene oxide condensates of (meth)acrylates, H₂C═C(CH₃)COO(CH₂CH₂O)ₙP(O)(OH)₂, and analogous propylene and butylene oxide condensates, where n is an amount of 1 to 50, phosphoalkyl crotonates, phosphoalkyl maleates, phosphoalkyl fumarates, phosphodialkyl (meth)acrylates, phosphodialkyl crotonates, vinyl phosphonic acid, allyl phosphonic acid, 2-acrylamido-2-methylpropanephosphinic acid, 2-acrylamido-2-methyl propane sulfonic acid or a salt thereof (such as sodium, ammonium, or potassium salts), α-phosphonostyrene, 2-methylacrylamido-2-methylpropanephosphinic acid, (hydroxy)phosphinylalkyl(meth)acrylates, (hydroxy)phosphinylmethyl methacrylate, and combinations thereof. In some embodiments, the copolymer includes 2-acrylamido-2-methyl propane sulfonic acid.

Hydroxy (meth)acrylates that can be included in the copolymer include, for example, hydroxyl functional monomers defined by the general Formula VII below

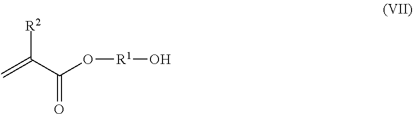

wherein R¹ is hydrogen or methyl and R₂ is hydrogen, a C₁-C₄ alkyl group, or a phenyl group. For example, the hydroxyl (meth)acrylate can include hydroxypropyl (meth)acrylate, hydroxybutylacrylate, hydroxybutylmethacrylate, hydroxyethylacrylate (HEA) and hydroxyethylmethacrylate (HEMA).

Other suitable additional monomers that can be included in the copolymer include (meth)acrylonitrile, vinyl halides, vinyl ethers of an alcohol comprising 1 to 10 carbon atoms, aliphatic hydrocarbons having 2 to 8 carbon atoms and one or two double bonds, phosphorus-containing monomers, acetoacetoxy monomers, sulfur-based monomers, hydroxyl (meth)acrylate monomers, methyl (meth)acrylate, ethyl (meth)acrylate, alkyl crotonates, di-n-butyl maleate, di-octylmaleate, acetoacetoxyethyl (meth)acrylate, acetoacetoxypropyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2 ethoxyethoxy)ethyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, 2,3-di(acetoacetoxy)propyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, or combinations thereof.

When present, the one or more additional monomers can be present in small amounts (e.g., 10% by weight or less, 7.5% by weight or less, 5% by weight or less, 4% by weight or less, 3% by weight or less, 2% by weight or less, 1.5% by weight or less, 1% by weight or less, or 0.5% by weight or less), based on the total weight of monomers from which the copolymer is derived. The one or more additional monomers when present can be present in an amount of greater than 0%, 0.1% by weight or greater, 0.3% or greater, 0.5% or greater, 0.75% or greater, or 1% or greater by weight, based on the total weight of monomers from which the copolymer is derived.

In some embodiments, the monomers in the copolymer can be polymerized in the presence of a chain transfer agent. A “chain transfer agent” as used herein refers to chemical compounds that are useful for controlling the molecular weights of polymers, for reducing gelation when polymerizations and copolymerizations involving diene monomers are conducted, and/or for preparing polymers and copolymers with useful chemical functionality at their chain ends. The chain transfer agent reacts with a growing polymer radical, causing the growing chain to terminate while creating a new reactive species capable of initiating polymerization. The phrase “chain transfer agent” is used interchangeably with the phrase “molecular weight regulator.”

Suitable chain transfer agents for use during polymerization of the copolymers disclosed herein can include compounds having a carbon-halogen bond, a sulfur-hydrogen bond, a silicon-hydrogen bond, or a sulfur-sulfur bond; an allyl alcohol, or an aldehyde. In some embodiments, the chain transfer agents contain a sulfur-hydrogen bond, and are known as mercaptans. In some embodiments, the chain transfer agent can include C₃-C₂₀ mercaptans. Specific examples of the chain transfer agent can include octyl mercaptan such as n-octyl mercaptan and t-octyl mercaptan, decyl mercaptan, tetradecyl mercaptan, hexadecyl mercaptan, dodecyl mercaptan such as n-dodecyl mercaptan and t-dodecyl mercaptan, tert-butyl mercaptan, mercaptoethanol such as β-mercaptoethanol, 3-mercaptopropanol, mercaptopropyltrimethoxysilane, tert-nonyl mercaptan, tert-dodecyl mercaptan, 6-mercaptomethyl-2-methyl-2-octanol, 4-mercapto-3-methyl-1-butanol, methyl-3-mercaptopropionate, butyl-3-mercaptopropionate, i-octyl-3-mercaptopropionate, i-decyl-3-mercaptopropionate, dodecyl-3-mercaptopropionate, octadecyl-3-mercaptopropionate, and 2-phenyl-1-mercapto-2-ethanol. Other suitable examples of chain transfer agents that can be used during polymerization of the copolymers include thioglycolic acid, methyl thioglycolate, n-butyl thioglycolate, i-octyl thioglycolate, dodecyl thioglycolate, octadecyl thioglycolate, ethylacrylic esters, terpinolene. In some examples, the chain transfer agent can include tert-dodecyl mercaptan.

In some embodiments, the monomers in the copolymer are polymerized in the absence of a chain transfer agent.

When used, the amount of chain transfer agent utilized during polymerization can be present in an amount of at least 1 part by weight per hundred monomers present in the copolymer. For example, the chain transfer agent can be present in an amount of from 1 part to 4 parts, from 1.5 parts to 4 parts, from 1 part to 3.5 parts, from 1.5 parts to 3.5 parts, from 1 part to 3 parts, from 1.5 parts to 3 parts, or from 1 part to 2.5 parts by weight per hundred monomers present in the copolymer during polymerization. When the chain transfer agent is used, the resulting copolymer can contain from about 0.01% to about 4%, from about 0.05% to about 4%, from about 0.1% to about 4%, or from about 0.1% to about 3.5% by weight of the chain transfer agent.

The copolymers described herein can have a theoretical glass-transition temperature (Tg) and/or a Tg as measured by differential scanning calorimetry (DSC) using the mid-point temperature using the method described, for example, in ASTM 3418/82, of 25° C. or less (e.g., 20° C. or less, 15° C. or less, 12° C. or less, 10° C. or less, 8° C. or less, 5° C. or less, 3° C. or less, 1° C. or less, 0° C. or less, −3° C. or less, −5° C. or less, −10° C. or less, −15° C. or less, −20° C. or less, −25° C. or less, −30° C. or less, −35° C. or less, or −40° C. or less). The copolymers can have a theoretical Tg and/or a Tg as measured by DSC using the mid-point temperature using the method described, for example, in ASTM 3418/82, of −70° C. or greater (e.g., −65° C. or greater, −60° C. or greater, −55° C. or greater, −50° C. or greater, −45° C. or greater, −40° C. or greater, −35° C. or greater, −30° C. or greater, −25° C. or greater, −20° C. or greater, −15° C. or greater, −10° C. or greater, −5° C. or greater, 0° C. or greater, 5° C. or greater, 10° C. or greater, 15° C. or greater, or 20° C. or greater). The copolymers can have a theoretical Tg and/or a Tg as measured by DSC using the mid-point temperature using the method described, for example, in ASTM 3418/82, ranging from any of the minimum values described above to any of the maximum values described above. For example, the copolymers can have a theoretical glass-transition temperature (Tg) and/or a Tg as measured by differential scanning calorimetry (DSC) using the mid-point temperature using the method described, for example, in ASTM 3418/82, of from −70° C. to 25° C. (e.g., from −70° C. to 15° C., from −70° C. to 0° C., from −70° C. to less than 0° C., from −60° C. to 25° C., from −60° C. to 10° C., from −60° C. to 0° C., from −60° C. to less than 0° C., from −50° C. to 10° C., from −50° C. to 0° C., from −35° C. to 10° C., or from −35° C. to 0° C.). The theoretical glass transition temperature or “theoretical T_{g}” of the copolymer refers to the estimated T_{g} calculated using the Fox equation. The Fox equation can be used to estimate the glass transition temperature of a polymer or copolymer as described, for example, in L. H. Sperling, “Introduction to Physical Polymer Science”, 2^{nd} Edition, John Wiley & Sons, New York, p. 357 (1992) and T. G. Fox, Bull. Am. Phys. Soc, 1, 123 (1956), both of which are incorporated herein by reference. For example, the theoretical glass transition temperature of a copolymer derived from monomers a, b, . . . , and i can be calculated according to the equation below

$$\frac{1}{{T}_{g}} = \frac{{w}_{a}}{{T}_{g a}} + \frac{{w}_{b}}{{T}_{g b}} + … + \frac{{w}_{i}}{{T}_{g i}}$$

where wₐ is the weight fraction of monomer a in the copolymer, T_{g}a is the glass transition temperature of a homopolymer of monomer a, w_{b} is the weight fraction of monomer b in the copolymer, T_{gb} is the glass transition temperature of a homopolymer of monomer b, wᵢ is the weight fraction of monomer i in the copolymer, T_{gi} is the glass transition temperature of a homopolymer of monomer i, and T_{g} is the theoretical glass transition temperature of the copolymer derived from monomers a, b, . . . , and i.

The weight average molecular weight of the copolymers can be less than 50,000 Da. In some embodiments, the weight average molecular weight of the copolymers can be 25,000 Da or less (e.g., 20,000 Da or less, 15,000 Da or less, 14,000 Da or less, 12,000 Da or less, 10,000 Da or less, 9,000 Da or less, 8,000 Da or less, 7,000 Da or less, 6,000 Da or less, 5,000 Da or less, 4,000 Da or less, 3,000 Da or less, or 2,000 Da or less, or 1,500 Da or less). In some embodiments, the weight average molecular weight of the copolymers can be from 1,000 Da to 25,000 Da, from 1,000 Da to 15,000 Da, from 1,500 Da to 13,000 Da, from 2,500 Da to 13,000 Da, or from 4,000 Da to 13,000 Da.

The copolymers disclosed herein can be used in a wide range of applications that can use curable compositions. As described herein, the compositions are formulated to cure by crosslinking when exposed to moisture in the environment. In some examples, the copolymers can be used in curable applications including adhesives, potting compounds, caulks, mold making, sealing compositions for structures, boats and ships, automobiles, roads and the like, blocking agents, insulation, vibration dampers, acoustic insulation, foamed materials, paints, spraying materials, waterproofing compositions, coatings in sanitary rooms, glazing, prototyping, joint seals between different materials, e.g. sealants between ceramic or mineral surfaces and thermoplastics, paper releases, impregnants, and the like. Furthermore, the copolymer composition when used, for example, as a coating or adhesive, can adhere onto a broad variety of metal, wood, mineral, ceramic, rubber or plastic surfaces. The compositions can have a Brookfield viscosity of 10,000 cps or greater, 15,000 cps or greater, 25,000 cps or greater, from 10,000 cps to 100,000 cps, from 10,000 cps to 50,000 cps, or from 25,000 cps to 60,000 cps, determined at 25° C. and 20 rpm using a #7 spindle. The compositions can have a solids weight % of greater than 50%, 80% or greater, from 50% to 99%, or from 80% to 99%.

In some embodiments, the copolymer can be used in coating formulations, for example, in adhesive formulations. The adhesives formulations can include flooring adhesives, pressure-sensitive adhesives, elastic adhesives, contact-type adhesives, tiling adhesives, powder coating, medical adhesives, adhesives for interior panels, adhesives for exterior panels, tiling adhesives, stone finishing adhesives, ceiling finishing adhesives, floor finishing adhesives, wall finishing adhesives, vehicle paneling adhesives, and electric or electronic or precision equipment assembly adhesives. The adhesive formulations can further include one or more additives such as one or more on enhancers (also referred to as adhesion promoters), coalescing aids/agents (coalescents), film forming aids (i.e., plasticizers), water scavengers, defoamers, fillers, pigments, thickeners, biocides, crosslinking agents, flame retardants, stabilizers, moisture cure catalysts, and corrosion inhibitors. In some embodiments, the adhesive formulation does not include (is free of) water scavengers. The adhesive compositions can have a Brookfield viscosity of 25,000 cps or greater, from 25,000 cps to 100,000 cps, or from 25,000 cps to 60,000 cps, determined at 25° C. and 20 rpm using a #7 spindle. The compositions can have a solids weight % of 80% or greater, from 50% to 99%, or from 80% to 99%.

Since the compositions can be closely adhered to a wide range of substrates such as glass, porcelain, wood, metal, resin molded products and the like by itself or with the aid of a primer, the copolymer can also be used as various types of tight-sealing compositions. In some embodiments, the copolymer can be used in sealant formulations. The sealant formulations can be used for architectural sealings for sealing joints having a wide variety of different materials, for example of stones such as granite and marble, concrete, mineral substrates, porcelain, metals, glass, ceramics, wood, resins, painted surfaces or substrates, and plastics including PVC. The sealant formulations can further include one or more additives such as one or more on enhancers, moisture cure catalysts, film forming aids (i.e., plasticizers), silicone resins, water scavengers, fillers, pigments, thickeners, biocides, flame retardants, and corrosion inhibitors. In some instances, the sealant compositions can include an unreactive plasticizer known in the art and may include silane-crosslinking systems such as phthalic esters, adipic esters, benzoic esters, glycol esters, and esters of saturated alkanediols. Sealant formulations are described in U.S. Pat. Nos. 9,523,002 and 9,920,229 which are incorporated herein by reference in their entirety.

In some embodiments, the copolymer can be used in waterproofing formulations. The waterproofing formulations can provide a liquid-applied moisture-permeable waterproofing material that can be applied easily and used, for example, to protect a building from rainwater or humidity in the air and to drain moisture that has been gathered on a substrate of a building. The waterproofing formulations can be used around an opening such as a window or a door. The waterproofing formulations can further include one or more additives such as one or more on enhancers, coalescing aids/agents, plasticizers, water scavengers, fillers, pigments, thickeners, biocides, crosslinking agents, amine compounds, flame retardants, stabilizers, moisture cure catalysts, and corrosion inhibitors. Waterproofing formulations are described in U.S. Pat. No. 9,217,060 which is incorporated herein by reference in its entirety.

In some examples, the waterproofing formulations can be used in roofing applications to provide a durable, breathable, weatherproof barrier that is resistant to rain, snow, sun, wind, air moisture, UV degradation, and natural weathering over a wide temperature range. The compositions may also provide thermal insulation, shock resistance, vibration resistance/noise reduction, electrical insulation, and/or non-slip properties. The composition can include additives such as mineral fillers, carriers, crosslinking agents, catalysts, and colorants.

The copolymer can be present in an amount of 60% by weight or greater, based on the total amount of polymers in the compositions described herein. For example, the copolymer can be present in an amount of 65% by weight or greater, 70% by weight or greater, 75% by weight or greater, 80% by weight or greater, 85% by weight or greater, 90% by weight or greater, 95% by weight or greater, 95% by weight or greater, or up to 100% by weight or greater, based on the total amount of polymers in the compositions described herein.

The copolymer can be present in an amount of 10% by weight or greater, based on the total weight of the compositions described herein. For example, the copolymer can be present in an amount of 15% by weight or greater, 20% by weight or greater, 25% by weight or greater, 30% by weight or greater, 35% by weight or greater, 40% by weight or greater, 45% by weight or greater, 50% by weight or greater, or up to 100% by weight, based on the total weight of the compositions described herein. In some examples, the copolymer can be present in an amount of from 10% up to 100%, from 10% to 95%, from 10% to 65%, from 10% to 50%, from 20% to 65%, from 30% to 95%, from 40% to 90%, or from 50% to 90%, by weight of the composition.

Inorganic Filler

As described herein, the compositions can further include at least one inorganic filler, also referred to herein as pigments or mineral pigments. Examples of suitable inorganic fillers that can be included in the compositions can be selected from TiO₂ (in both anastase and rutile forms), clay (aluminum silicate), CaCO₃ (in both ground and precipitated forms), aluminum oxide, silicon dioxide, magnesium oxide, talc (magnesium silicate), bentonite, barytes (barium sulfate), zinc oxide, zinc sulfite, sodium oxide, zeolite, potassium oxide and mixtures thereof. Examples of commercially available titanium dioxide pigments are KRONOS® 2101, KRONOS® 2310, available from Kronos WorldWide, Inc., TI-PURE® R-900, available from DuPont, or TIONA® AT1 commercially available from Millennium Inorganic Chemicals. Titanium dioxide is also available in concentrated dispersion form. An example of a titanium dioxide dispersion is KRONOS® 4311, also available from Kronos WorldWide, Inc. Suitable pigment blends of metal oxides are sold under the marks MINEX® (oxides of silicon, aluminum, sodium and potassium commercially available from Unimin Specialty Minerals), CELITE® (aluminum oxide and silicon dioxide commercially available from Celite Company), and ATOMITE® (commercially available from Imerys Performance Minerals). Exemplary fillers also include clays such as attapulgite clays and kaolin clays including those sold under the ATTAGEL® and ANSILEX® marks (commercially available from BASF Corporation). Additional fillers include nepheline syenite, (25% nepheline, 55% sodium feldspar, and 20% potassium feldspar), feldspar (an aluminosilicate), diatomaceous earth, calcined diatomaceous earth, talc (hydrated magnesium silicate), aluminosilicates, silica (silicon dioxide), alumina (aluminum oxide), mica (hydrous aluminum potassium silicate), pyrophyllite (aluminum silicate hydroxide), perlite, baryte (barium sulfate), wollastonite (calcium metasilicate), and combinations thereof. More preferably, the at least one filler includes TiO₂, CaCO₃, and/or a clay.

Generally, the mean particle sizes of the inorganic filler ranges from about 0.01 to about 50 microns. For example, calcium carbonate particles used in the composition can have a median particle size of from about 0.15 to about 10 microns, such as from about 0.5 to about 7 microns or from about 0.5 to about 5 microns. The filler can be added to the composition as a powder or in slurry form.

The inorganic filler can be present in an amount of 0% by weight or greater, based on the total weight of the compositions described herein. For example, the inorganic filler can be present in an amount of 5% by weight or greater, 10% by weight or greater, 15% by weight or greater, 20% by weight or greater, 25% by weight or greater, 30% by weight or greater, 35% by weight or greater, 40% by weight or greater, 45% by weight or greater, 50% by weight or greater, 55% by weight or greater, 60% by weight or greater, 65% by weight or greater, or up to 80% by weight or greater, based on the total weight of the compositions described herein. In some embodiments, the inorganic filler can be present in an amount of from 0% to 80% by weight, such as from greater than 0% to 80% by weight, from 5% to 80% by weight, from 20% to 80% by weight, from 40% to 80% by weight, from 50% to 80% by weight, from 30% to 75% by weight, from 45% to 65% by weight, based on the total weight of the compositions described herein. In some embodiments, the compositions such as adhesive compositions do not include a filler.

In some examples, the compositions can further include at least one organic filler such as polyalkylene fibers, preferably polyethylene fibers.

Adhesion Enhancers

The compositions described herein can include an adhesion enhancer (adhesion promoter). An adhesion enhancer can be added to improve the adhesion of a substrate (such as wood, laminate, or tile) to the surface it is bonded, for example, wood, concrete, metal, metal primer or coating the metal. Adhesion enhancers known to those skilled in the art can be used. Examples of suitable adhesion enhancers for improving adhesion include silane containing compounds, such as organosilanes, aminosilanes, epoxysilanes, amino alkoxy silanes, vinyl alkoxy silanes, isocyanato alkoxy silanes, isocyanurate functional alkoxy silanes, (meth)acrylic silanes, anhydridosilanes or adducts of the aforementioned silanes with primary aminosilanes, aminosilanes or urea silanes, polyamines such as polyethyleneimine, or combinations thereof. Specific examples of adhesion enhancers can include vinyltriethoxysilane, vinyltrimethoxysilane, vinyl tris(2-methoxyethoxysilane), vinyl triisopropoxysilane, (meth)acryloyloxypropyl trimethoxysilane, γ-(meth)acryloxypropyl trimethoxysilane, γ-(meth)acryloxypropyl triethoxysilane, (3-methacryloxypropyl)-trimethoxysilane, (3-methacryloxypropyl)-triethoxy silane, (3-methacryloxypropyl)-triisopropoxysilane, 2-methyl-2-propenoic acid 3-[tris-(1-methylethoxy)-silyl]-propyl ester, (3-methacryloxypropyl)-methyldiethoxysilane, 3-glycidoxypropyl methyldiethoxysilane, 3-glycidoxypropyl methyldimethoxysilane, or a mixture thereof. In some examples, the organosilane comprises vinyltrimethoxysilane, vinyltriethoxysilane, vinyl tris(2-methoxyethoxysilane), vinyl triisopropoxysilane, gamma-methacryloxypropyltrimethoxy silane, or combinations thereof. For example, the organosilane can comprise vinyltriethoxysilane, gamma-glycidoxypropyltrimethoxysilane, gamma-aminopropyltrimethoxysilane, gamma-isocyanato propyl trimethoxysilane, n-beta-(aminoethyl) gamma-aminopropyl trimethoxysilane, n-(2-aminoethyl)-3-aminopropyl methyl dimethoxysilane, 3-aminopropyl methyl dimethoxy silane, bis-(gamma-trimethoxysilylpropyl amine), n-phenyl-gamma-aminopropyltrimethoxysilane, gamma-isocyanato propyl methyl dimethoxy silane, beta-(3,4-epoxycyclohexyl) ethyl triethoxysilane, gamma-glycidoxypropyltrimethoxysilane, (gamma trimethoxysilylpropyl) isocyanurate, vinyltrimethoxysilane, vinyl triglycidoxyipropylmethylsilane, aminosilanes having a structure represented by Formula I, or a combination thereof. In some embodiments, the adhesion enhancer can include polyamines (i.e., polymers formed from either an amine-group containing monomer or an imine monomer as polymerized units such as aminoalkyl vinyl ether or sulfides; acrylamide or acrylic esters, such as dimethylaminoethyl(meth)acrylate; N-(meth)acryloxyalkyl-oxazolidines such as poly(oxazolidinylethyl methacrylate), N-(meth)acryloxyalkyltetrahydro-1,3-oxazines, and monomers that readily generate amines by hydrolysis). Suitable polyamines can include, for example, poly(oxazolidinylethyl methacrylate), poly(vinylamine), or polyalkyleneimine (e.g., polyethyleneimine).

In some embodiments, the adhesion enhancer comprises a silane group having a reactive moiety reactive with active hydrogen atoms, such as active hydrogen atoms present in the copolymer. Such silanes can include organosilanes such as a mercapto-silane, an amino-trialkoxy silane, or an amino trialkoxysilane. The adhesion enhancer can be present in an amount sufficient to improve the extent that the common measurement for the purpose of adhesion to a surface for adhesive testing by the failure mode of the bond to the lap shear strength and the substrate. In some embodiments, the amount of the adhesion enhancer present in the compositions can be 0% by weight or greater (e.g., 1% by weight or greater, 2% by weight or greater, 3% by weight or greater, 4% by weight or greater, 5% by weight or greater, 6% by weight or greater, 8% by weight or greater, 10% by weight or greater, 12% by weight or greater, or 15% by weight or greater), based on the total weight of the composition. In some embodiments, the adhesion enhancer can be present in the composition in an amount of 15% by weight or less (e.g., 12% by weight or less, 10% by weight or less, 8% by weight or less, 7% by weight or less, 6% by weight or less, 5% by weight or less, 4% by weight or less, 3% by weight or less, or 2.5% by weight or less) based on the total weight of the adhesive composition. The composition can include any of the minimum values to any of the maximum values by weight described above of the adhesion enhancer. For example, when present, the composition can include from greater than 0% to 15% by weight (e.g., from greater than 0% to 10%, from 1% to 10%, or from greater than 0% to 5% by weight of the adhesion enhancer), based on the total weight of the adhesive composition. Other suitable adhesion enhancers are described in U.S. Pat. No. 9,534,158 which is incorporated herein by reference in its entirety.

Film-Forming Aids

The composition can further comprise a film forming aid (i.e., a plasticizer). Such materials preferably do not contain water, are miscible with the copolymer, and do not include a reactive group. Suitable film forming aids are known in the art and can include alkyl phthalates, for example, dialkyl phthalates (wherein the alkyl phthalate is mixed C₇, C₉ and C₁₁ linear having an alkyl group), carbonyl phthalate, di-iso-dodecyl phthalate, dioctyl phthalate or dibutyl phthalate, diisononyl phthalate, adipates such as dioctyl adipate, azelates and sebacates, polyols such as polyoxyalkylene polyols or polyester polyols, organic phosphoric- and sulfonic acid esters or polybutenes, hydrogenated terpenes, trioctyl phosphate, epoxy plasticizers, chloro-paraffins, adipic acid esters, n-methylpyrrolidinone, and alkyl naphthalene. Other suitable plasticizers include diethylene glycol dibenzoate, dipropylene glycol dibenzoate, tripropylene glycol dibenzoate, butyl benzyl phthalate, or a combination thereof.

Film forming aids can be added to the compositions to reduce the glass transition temperature (T_{g}) of the compositions below that of the drying temperature to allow for good film formation. The film forming aid can be present in an amount of from 1% to 15%, based on the dry weight of the copolymer. For example, the film forming aid can be present in an amount of from 5% to 15% or from 7% to 15%, based on the dry weight of the copolymer. In some embodiments, the film forming aid can be present in an effective amount to provide compositions having a measured Tg less than ambient temperature (e.g., 20° C.). In some embodiments, the compositions do not include a plasticizer or a film forming aid. Other suitable plasticizers are described in U.S. Pat. No. 9,534,158 which is incorporated herein by reference in its entirety.

Coalescing Aids

In some embodiments, the compositions can include one or more coalescing aids. Suitable coalescing aids, which aid in film formation during drying, include ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, propylene glycol n-butyl ether, dipropylene glycol n-butyl ether, 2,2,4-trimethyl-1,3-pentanediol monoisobutyrate, or combinations thereof. In some embodiments, the compositions can include one or more coalescing aids such as propylene glycol n-butyl ether and/or dipropylene glycol n-butyl ether.

Water Scavenger

As described herein, the composition can include a water scavenger. Suitable water scavengers can include trimethyl orthoacetate, triethyl orthoacetate, trimethyl orthoformate, triethyl orthoformate, organosilanes such as vinyltrimethoxysilane and vinyltriethoxysilane, α-functional silanes such as N-(silylmethyl)-O-methyl-carbamates, in particular N-(methyldiethoxysilylmethyl)-O-methyl-carbamate, (methacryloxymethyl)silanes, ethoxymethylsilanes, N-phenyl-, N-cyclohexyl- and N-alkylsilanes, orthoformic acid esters, calcium oxide, molecular sieves, or mixtures thereof. The water scavenger can be present in an amount of from 0% (greater than 0%) to 5% by weight, based on the weight of the composition.

Preferably, the copolymer is produced under anhydrous conditions. In some instances, a water scavenger can be included during or after polymerization to capture water. In some embodiments, the compositions comprise less than 0.1% by weight water, preferably less than 0.05% by weight water, more preferably the composition is anhydrous. Preferably, the compositions such as adhesive compositions are also free of isocyanates.

Moisture Cure Catalysts

The compositions described herein can be cured via a moisture curing mechanism. In some examples, the compositions include a moisture curing catalyst. Moisture curing catalysts are known from the literature, for example G. Oertel (ed.), Polyurethane, 3rd edition 1993, Carl Hanser Verlag, Munich-Wien, pages 104 to 110, section 3.4.1. Further metal catalysts are described by Blank et al. described in Progress in Organic Coatings, 1999, Vol. 35, pages 19-29. The catalyst may promote crosslinking reaction through hydrolysis condensation reaction.

Preferably, the catalysts are tin-free catalysts. For example, the catalysts can include metal complexes such as acetylacetonates of iron, titanium, aluminum, zirconium, manganese, nickel, zinc and cobalt. In some examples, the catalyst can include zirconium compounds such as zirconium tetraacetylacetonate (e.g., K-KAT™ 4205; K-KAT™ 5218, K-KAT™ XC 9213, XC-A 209, and XC-6212 from King Industries); bismuth compounds, in particular tricarboxylic carboxylates (e.g., K-KAT™ 348, XC-B221; XC-C227, XC 8203 from King Industries). Tin and zinc-free catalysts from Borchers, available under the trade name Borchi® Cat can also be used. For example, the moisture cure catalyst can include BORCHI® KAT 24. Cesium salts can also be used as catalysts. Examples of tin compounds include tin (II) salts of organic carboxylic acids, for example tin (II) diacetate, tin (II) bis(ethylhexanoate), tin (II) dilaurate, dialkyltin (IV) salts of organic carboxylic acids, for example, dimethyltin diacetate, dibutyltin diacetate, dibutyltin dibutyrate, dibutyltin bis dilaurate (2-ethylhexanoate), dibutyltin, dibutyltin maleate, dioctyltin dilaurate and dioctyltin diacetate. In addition, zinc (II) salts can be used, such as zinc (II) diactetate. Preferably, the moisture cure catalyst is free of tin.

Other examples of suitable catalysts can include amine-based catalysts. Examples of amine-based catalysts include aliphatic primary amines such as methylamine, ethylamine, propylamine, isopropylamine, butylamine, amylamine, hexylamine, octylamine, 2-ethylhexylamine, nonylamine, decylamine, laurylamine, pentadecylamine, cetylamine, stearylamine, and cyclohexylamine; aliphatic secondary amines such as dimethylamine, diethylamine, dipropylamine, diisopropylamine, dibutylamine, diamylamine, dihexylamine, dioctylamine, di(2-ethylhexyl)amine, didecylamine, dilaurylamine, dicetylamine, distearylamine, methylstearylamine, ethylstearylamine, and butylstearylamine; aliphatic tertiary amines such as triamylamine, trihexylamine, and trioctylamine; aliphatic unsaturated amines such as triallylamine and oleylamine; aromatic amines such as aniline, laurylaniline, stearylaniline, and triphenylamine; nitrogen-containing heterocyclic compounds such as pyridine, 2-aminopyridine, 2-(dimethylamino)pyridine, 4-(dimethylamino pyridine), 2-hydroxypyridine, imidazole, 2-ethyl-4-methylimidazole, morpholine, N-methylmorpholine, piperidine, 2-piperidinemethanol, 2-(2-piperidino)ethanol, piperidone, 1,2-dimethyl-1,4,5,6-tetrahydropyrimidine, 1,8-diazabicyclo(5,4,0)undecene-7 (DBU), 6-(dibutylamino)-1,8-diazabicyclo(5,4,0)undecene-7 (DBA-DBU), 1,5-diazabicyclo(4,3,0)nonene-5 (DBN), 1,4-diazabicyclo(2,2,2)octane (DABCO), and aziridine; and other amines such as monoethanolamine, diethanolamine, triethanolamine, 3-hydroxypropylamine, ethylenediamine, propylenediamine, hexamethylenediamine, N-methyl-1,3-propanediamine, N,N′-dimethyl-1,3-propanediamine, diethylenetriamine, triethylenetetramine, 2-(2-aminoethylamino)ethanol, benzylamine, 3-methoxypropylamine, 3-lauryloxypropylamine, 3-dimethylaminopropylamine, 3-diethylaminopropylamine, 3-dibutylaminopropylamine, 3-morpholinopropylamine, 2-(1-piperazinyl)ethylamine, xylylenediamine, and 2,4,6-tris(dimethylaminomethyl)phenol; guanidines such as guanidine, phenylguanidine, and diphenylguanidine; and biguanides such as butylbiguanide, 1-o-tolylbiguanide, and 1-phenylbiguanide.

Amidines such as 1,2-dimethyl-1,4,5,6-tetrahydropyrimidine, DBU, DBA-DBU, and DBN; guanidines such as guanidine, phenylguanidine, and diphenylguanidine; and biguanides such as butylbiguanide, 1-o-tolylbiguanide, and 1-phenylbiguanide have high catalytic activity. High adhesion for aryl-substituted biguanides such as 1-o-tolylbiguanide and 1-phenylbiguanide can be expected. Amine compounds whose conjugate acids have a pKa of 11 or higher have high catalytic activity. Amine compounds such as 1,2-dimethyl-1,4,5,6-tetrahydropyrimidine, DBU, and DBN have high catalytic activity because their conjugate acids have a pKa of 12 or higher. The moisture cure catalysts can be present in an amount of from 0% (or greater than 0%) to 20% by weight, from 0% (or greater than 0%) to 10% by weight, or from greater than 0% to 5% by weight, based on the weight of the composition.

Other suitable additives to the compositions can include defoamers. Defoamers serve to minimize frothing during mixing and/or application of the components. Suitable defoamers include organic defoamers such as mineral oils, silicone oils, and silica-based defoamers. Exemplary silicone oils include polysiloxanes, polydimethylsiloxanes, polyether modified polysiloxanes, or combinations thereof. Exemplary defoamers include BYK®-035, available from BYK USA Inc., the TEGO® series of defoamers, available from Evonik Industries, the DREWPLUS® series of defoamers, available from Ashland Inc., and FOAMASTER® NXZ, available from BASF Corporation.

Examples of suitable rheology modifiers (thickeners) can include waxes such as polyamide waxes, hydrogenated castor oil derivatives, bentonites, pyrogenic silicic acids, fumed silica-based thickeners, and metal soaps such as calcium stearate, aluminum stearate, barium stearate, and mixtures thereof. In some embodiments, the filler can provide rheological properties to the compositions. In some embodiments, the thickeners can be added to the composition formulation to produce a Brookfield viscosity of 25 Pa·s or greater (e.g., 30 Pa·s or greater, 35 Pa·s or greater, 40 Pa·s or greater, from 25-100 Pa·s, from 25-75 Pa·s, from 25-60 Pa·s, or from 30-60 Pa·s,) at 25° C. The Brookfield viscosity can be measured using a Brookfield type viscometer with a #7 spindle at 20 rpm at 25° C.

Suitable carriers can include fluid carrier such as cyclomethicones, which are a group of methyl siloxanes, a class of liquid silicones (cyclic polydimethylsiloxane polymers) that possess the characteristics of low viscosity and high volatility. Cyclomethicones have short backbones that make closed or nearly-closed rings with their methyl groups. Octamethylcyclotetrasiloxane, also called D4, is an organosilicon compound with the formula [(CH₃)₂SiO]₄ that generally is less volatile than other cyclomethicones. The amount of fluid carrier used normally is about 7 wt. % based on the total weight of the composition.

Suitable biocides can be incorporated to inhibit the growth of bacteria, algae, fungi, and other microbes in the composition during storage. Exemplary biocides include 2-[(hydroxymethyl)amino]ethanol, 2-[(hydroxymethyl) amino]2-methyl-1-propanol, o-phenylphenol, sodium salt, 1,2-benzisothiazolin-3-one, 2-methyl-4-isothiazolin-3-one (MIT), 5-chloro2-methyland-4-isothiazolin-3-one (CIT), 2-octyl-4-isothiazolin-3-one (OIT), 4,5-dichloro-2-n-octyl-3-isothiazolone, as well as acceptable salts and combinations thereof. Suitable biocides also include biocides that inhibit the growth of mold, mildew, and spores thereof in the compositions. Examples of mildewcides include 2-(thiocyanomethylthio)-benzothiazole, 3-iodo-2-propynyl butyl carbamate, 2,4,5,6-tetrachloroisophthalonitrile, 2-(4-thiazolyl)benzimidazole, 2-N-octyl4-isothiazolin-3-one, diiodomethyl p-tolyl sulfone, as well as acceptable salts and combinations thereof. In certain embodiments, the composition contains 1,2-benzisothiazolin-3-one or a salt thereof. Biocides of this type include PROXEL® BD20, commercially available from Arch Chemicals, Inc. The biocide can alternatively be applied as a film and a commercially available film-forming biocide is Zinc Omadine® commercially available from Arch Chemicals, Inc.

The compositions can further include stabilizers, for example, against heat, light and UV radiation, antioxidants, tackifier resins, flame-retardant substances, surface-active substances such as crosslinking agents, non-functional co-binders, including, but not limited to, polyacrylic, polyester, polyurethane or polysiloxane resins, epoxy resins, epoxy resin-curing agents, photocurable substances, oxygen curable substances, silanol-containing compounds, curability modifiers, radical inhibitors, metal deactivators, flow-control agents, aerating agents, phosphorus-containing peroxide decomposers, lubricants, foaming agents, repellents, and other substances customarily used in moisture-curing compositions.

In some examples, a tackifier resin can be added as necessary to enhance adhesiveness to a substrate. Examples of suitable tackifiers include terpene-based resins, aromatic modified terpene resins, hydrogenated terpene resins, terpene-phenol resins obtained by copolymerizing terpenes with phenols, phenol resins, modified phenol resins, xylene-phenol resins, cyclopentadiene-phenol resins, coumarone-indene resins, rosin resins, rosin ester resins, hydrogenated rosin ester resins, xylene resins, low-molecular weight polystyrene-based resins, styrene copolymer resins, petroleum resins (e.g., C5 hydrocarbon resin, C9 hydrocarbon resin, C5C9 hydrocarbon copolymer resin etc.), hydrogenated petroleum resins, DCPD resins, and the like.

The use of an antioxidant can enhance the heat resistance of the cured product. Examples of the antioxidant include hindered phenol antioxidants, monophenol antioxidants, bisphenol antioxidants, and polyphenol antioxidants. Hindered phenol antioxidants are particularly preferred. Specific examples of the antioxidant also include those disclosed in U.S. Patent Publication No. 2015/0266271. The amount of antioxidant per 100 parts by weight of the copolymer is preferably in the range of 0.1 to 10 parts by weight, and more preferably 0.2 to 5 parts by weight.

The composition can include a photostabilizer to prevent photo oxidative degradation of the cured product. Examples of the photostabilizer include benzotriazole compounds, hindered amine compounds, and benzoate compounds. Hindered amine compounds are particularly preferred. The amount of photostabilizer per 100 parts by weight of copolymer is preferably in the range of 0.1 to 10 parts by weight, and more preferably 0.2 to 5 parts by weight. Specific examples of the photostabilizer are also disclosed in U.S. Patent Publication No. 2015/0266271.

The composition can include an ultraviolet absorber to increase the surface weather resistance of the cured product. Examples of the ultraviolet absorber include benzophenone compounds, benzotriazole compounds, salicylate compounds, substituted tolyl compounds, and metal chelate compounds. Benzotriazole compounds are particularly preferred. The amount of ultraviolet absorber per 100 parts by weight of the copolymer is preferably in the range of 0.1 to 10 parts by weight, and more preferably 0.2 to 5 parts by weight.

Exemplary co-solvents and humectants include ethylene glycol, propylene glycol, diethylene glycol, and combinations thereof.

The composition can further include a solvent to reduce the viscosity of the composition, enhance the thixotropy, and improve the workability. Specific examples of solvents include hydrocarbon solvents such as toluene, xylene, heptane, hexane, and petroleum solvents; halogenated solvents such as trichloroethylene; ester solvents such as ethyl acetate and butyl acetate; ketone solvents such as acetone, methyl ethyl ketone, and methyl isobutyl ketone; ether solvents; alcohol solvents such as methanol, ethanol, and isopropanol; and silicone solvents such as haxamethylcyciotrisiloxane, octamethylcyclotetrasiloxane, and decamethylcyclopentasiloxane. A large solvent content may be toxic to humans and may cause a reduction in cue volume of the cured product, and the like. Thus, the amount of solvent per 100 parts by weight in total of the copolymer is preferably less than 1 part by weight, more preferably less than 0.1 parts by weight, most preferably, substantially no solvent is contained.

As described herein, the copolymers described herein can be used in adhesive compositions. In some embodiments, the adhesive compositions can include an acrylic resin with silane functionality that is capable of moisture cure, at least one type of inorganic filler, an adhesion promoter, a moisture-cure catalyst, optionally a plasticizer or film-forming aid, a defoamer, a rheology modifier, a tackifier, a water scavenger, or a combination thereof.

The copolymer, the one or more aminosilanes, and the moisture cure catalyst can be present in the compositions in varying amounts so as to provide a resultant composition with the desired properties for a particular application. In some examples, the adhesive compositions can include a copolymer derived from one or more (meth)acrylates and one or more carboxylic acid anhydrides, an inorganic filler present in an amount of at least 5% by weight, based on the total weight of the adhesive composition, one or more aminosilanes, and a moisture cure catalyst, wherein the adhesive composition has a solids weight % of greater than 50%.

In some examples, the adhesive compositions can include a copolymer produced by radical polymerization and derived from monomers including one or more (meth)acrylates and one or more organosilanes, wherein the copolymer is derived in the absence of a chain transfer agent at a temperature of at least 150° C., an inorganic filler present in an amount of at least 5% by weight, based on the total weight of the adhesive composition, an adhesion enhancer, and a tin-free moisture cure catalyst, wherein the adhesive composition has a Brookfield viscosity of 10,000 cps or greater at 25° C. and 20 rpm using a #7 spindle, and a solids weight % of greater than 50%.

Methods

The copolymers and compositions disclosed herein can be prepared by any polymerization method known in the art. For example, the copolymers can be prepared by a method in which a polymer is prepared from one or more (meth)acrylate and one or more carboxylic acid anhydride monomers by the conventional process of free radical solution polymerization, and an aminosilane is stirred into a solution or melt of the polymer, usually in the course of a few minutes, the temperature being from 25° C. to 200° C. In some embodiments, the copolymer can be prepared from one or more (meth)acrylate and one or more organosilane monomers by free radical solution polymerization, the temperature being 150° C. or greater.

The solvent for the free radical solution polymerization can include an organic solvent. Examples of suitable solvents include ethers, such as tetrahydrofuran or dioxane, esters, such as ethyl acetate or n-butyl acetate, ketones, such as acetone or cyclohexanone, N,N-dialkylcarboxamide, such as N,N-dimethylformamide, N,N-dimethylacetamide or N-methyl-2-pyrrolidone, aromatics, such as toluene or xylene, aliphatic hydrocarbons, such as isooctane, chlorohydrocarbons, such as tert-butyl chloride, or plasticizers, such as di-n-butyl phthalate. Suitable initiators of free radical polymerization are organic azo compounds or organic peroxides, such as azobisisobutyronitrile, dibenzoyl peroxide or tert-butyl perbenzoate. Chain-transfer agents, such as aliphatic, aromatic or alicyclic mercaptans, e.g. n-butyl mercaptan or n-lauryl mercaptan, or alkyl thioglycolates, such as ethyl thioglycolate, are among the substances which can be added as further assistants. When used, preferred chain-transfer agents are mercaptoalkoxysilanes. In some examples, the polymerization is carried out without a chain transfer agent.

The solution polymerization can be carried out either as a batch, semi-batch, or continuous process. In some embodiments, a portion of the monomers can be heated to the polymerization temperature and partially polymerized, and the remainder of the polymerization batch can be subsequently fed to the polymerization zone continuously, in steps or with superposition of a concentration gradient. The process can use a single reactor or a series of reactors as would be readily understood by those skilled in the art.

In some embodiments, the copolymer solution can be prepared by first charging a reactor with suitable monomers and optionally a solvent. When a solvent is used, the solvent can include an organic solvent. The initial charge can then be heated to a temperature at or near the reaction temperature. As described herein, the reaction temperature can be, for example, between 70° C. and 250° C. (e.g., between 80° C. and 120° C., between 70° C. and 110° C., between 90° C. and 120° C.). For high temperature polymerization, the reaction temperature can be, for example, between 120° C. and 250° C. (e.g., between 150° C. and 250° C., or between 150° C. and 220° C.).

After the initial charge, the monomers that are to be used in the polymerization can be continuously fed to the reactor in one or more monomer feed streams. The monomers can be supplied as a solution. An initiator feed stream can also be continuously added to the reactor at the time the monomer feed stream is added although it may also be desirable to include at least a portion of the initiator solution to the reactor before adding a monomer stream if one is used in the process. The monomer and initiator feed streams are typically continuously added to the reactor over a predetermined period of time (e.g., 1.5-24 hours) to cause polymerization of the monomers and to thereby produce the polymer solution or melt.

As mentioned above, the monomer feed stream can include one or more monomers (e.g., a carboxylic acid anhydride, a (meth)acrylate monomer, an organosilane, and optionally additional monomers). The monomers can be fed in one or more feed streams with each stream including one or more of the monomers being used in the polymerization process. For example, the carboxylic acid anhydride, and the (meth)acrylate monomer can be provided in separate monomer feed streams. It can also be advantageous to delay the feed of certain monomers to provide certain polymer properties.

The initiator feed stream can include at least one initiator or initiator system that is used to cause the polymerization of the monomers in the monomer feed stream. The initiator stream can also include a solvent and other desired components appropriate for the monomer reaction to be initiated. The initiator can be any initiator known in the art for use in solution polymerization such as disclosed herein.

Once polymerization is completed, the polymer solution or melt can be stripped thereby decreasing its residual monomer content. This stripping process can include a physical stripping step. In some embodiments, the polymer solution or melt is physically stripped by evaporation. Once the stripping step is completed, additives including defoamers, coalescing aids, water scavengers, or a plasticizer can be added or at a later time if desired. Once the polymerization reaction is complete, and the stripping step is completed, the temperature of the reactor can be reduced.

As described herein, an anhydrous polymerization medium, i.e. one having a water content of less than 100 ppm, is advantageously used. The solution polymerization of the essentially anhydrous reactants can be carried out in the presence of small amounts of drying agents, such as tetraalkoxysilanes, e.g. tetramethoxysilane, or trialkyl orthoformates, e.g. triethyl orthoformate, with or without the addition of a Lewis acid. If required, the solvent can be separated off partially or completely from the resulting solutions of the starting polymers, for example by distillation under reduced pressure.

The copolymers can be obtainable in the presence or absence of a solvent by stirring an aminosilane into melts or solutions of the polymers, the reaction generally taking place within a few minutes even at room temperature.

The copolymers are relatively rapidly curable by the action of atmospheric humidity at room temperature and are thus suitable, in the presence or absence of a solvent, for the preparation of sealing compounds curable by atmospheric humidity. As described herein, the compositions can further include external plasticizers, inert fillers, thickeners, dyes, solvents, agents for increasing the aging resistance or active ingredients which accelerate curing by the action of atmospheric humidity. The amounts of additives are familiar to the skilled worker and are selected in accordance with the desired properties of the particular compound and advantageously stirred into the solutions or melts of the copolymers.

The copolymer compositions are characterized by curing which takes place rapidly, even at room temperature, under the action of atmospheric humidity and can be accelerated, if required, by adding a moisture cure catalyst, preferably a tin-free catalyst.

The compositions can be prepared in the form of a single-component system in which all components are mixed, and then stored in a sealed container. However, it can also be used in the form of a two-component system in which the polymer and the other components that are not the aminosilane (such as filler, catalyst, optional thickener, defoamer, water scavenger, film forming aid, and adhesion enhancer) are mixed to form one component, into which the aminosilane can be stirred as the second component before use. In the case of a single-component system, particular care must be taken to exclude water since otherwise premature curing of the sealing compound occurs. In the case of a two-component system, the presence of small traces of water in the polymer or other components are less critical, facilitating both processing of the starting components and storage of the composition.

As disclosed herein, the copolymers can be used in various compositions. The compositions can be used for several applications, including adhesives such as flooring adhesives, membranes, films, water-proof coatings, sealants, roof coatings, paints, carpet backing, foams, textiles, sound absorbing compounds, tape joint compounds, asphalt-aggregate mixtures, and asphalt roofing compounds.

The composition can be applied to a surface by any suitable coating technique, including spraying, rolling, brushing, or spreading (for example using a trowel). The composition can be applied in a single coat, or in multiple sequential coats (e.g., in two coats or in three coats) as required for a particular application. Generally, the composition is allowed to dry under ambient conditions. However, in certain embodiments, the composition can be dried, for example, by heating and/or by circulating air over the composition. The composition can have a thickness of 2 mils or greater, such as 5 mils or greater, 10 mils or greater, 15 mils or greater, 20 mils or greater, or 25 mils or greater. In some embodiments, the composition can have a thickness of 30 mils or less, such as 25 mils or less, 20 mils or less, 15 mils or less, 10 mils or less, or 5 mils or less.

The open time of the compositions can be at least 20 minutes, such as at least 25 minutes or at least 30 minutes. Open time refers to the time after applying the composition on a surface, and thus exposed to the atmosphere, that the composition can still adhere (wet) at least 50% of the substrate surface area.

Adhesive compositions including the copolymer as disclosed herein can exhibit a load at break of 80 lb_{f} or greater, preferably 90 lb_{f} or greater, and more preferably 100 lb_{f} or greater for a vinyl to cement board having a contact area of 1″×2″, determined by a lap shear test after 24 hours of standing at 23° C. and 50% relative humidity. In some embodiments, the adhesive compositions disclosed herein can exhibit a load at break of 130 lb_{f} or greater, preferably 150 lb_{f} or greater, and more preferably 170 lb_{f} or greater for a hardwood to cement board having a contact area of 1″×2″, determined by a lap shear test after 24 hours of standing at 23° C. and 50% relative humidity. The adhesive compositions can exhibit a 90° peel strength after 24 hours of contact time for vinyl to cement board having a contact area of 2″×6″ of 18 lb_{f} or greater, preferably 20 lb_{f} or greater, more preferably 22 lb_{f} or greater. In some embodiments, the adhesive compositions can exhibit a 90° peel strength after 7 days of contact time for hardwood to cement board having a contact area of 2″×6″ of 115 lb_{f} or greater, preferably 120 lb_{f} or greater.

The test used to determine the peel values from a substrate is as follows. The materials used include 3.5″×12″×½″ block composed of hardie board with self-leveling underlayment on the surface; ¼″× 3/16″× 5/16″ V-Notch, 2″×7″ hardwood floor strips (hole drilled at one end, measuring 1″ from edge), an Instron or other machine capable of measuring at least 100 lbs in tensile, 90 degree peel apparatus, 10 pounds PSA roller, and 1″ masking tape. The materials are conditioned for a minimum of 24 hrs at standard conditions (72+/−2° F., 50+/−5% R.H.). An area 2″×6″ wide measuring from the edge of each block is taped off using the masking tape. A sufficient amount of adhesive is applied at the top of the block to ensure adequate adhesive coverage of the 2″×6″ area. A trowel is positioned at approximately 75-degree angle to the block and the adhesive is slowly troweled down, using sufficient pressure on the trowel to leave adhesive on the block in the trowel groves only. The tape is then immediately removed from the plank. The adhesive is allowed to dry for a period of 20 min at standard lab conditions (72+/−2° F., 50+/−5% R.H.). After the drying period, hardwood floor strips are applied to the adhesive and lightly pressed down by hand only to adhere to the adhesive. The hole on the hardwood floor should not be on the adhesive surface. A 10-pound roller is then rolled back and forth on the hardwood floor for 5 complete cycles. Three samples obtained from above are placed in standard lab conditions (72+/−2° F., 50+/−5% R.H.) for a period of 1 day or 7 days. Upon completion of the specified curing time condition, the samples are placed in the 90 degree peel apparatus on Instron. The samples are peeled at 12 inches/minute. The peel strength is measured at maximum load in lbf. The peel strength and mode of failure (cohesive or adhesive failure, and general appearance) can be recorded.

The test used to determine the lap shear values from a substrate is as follows. The materials used include 3″×8″×½″ block composed of hardie board with self-leveling underlayment on surface; ¼″× 3/16″× 5/16″ V-Notch, 2″×2″ hardwood floor strips, an Instron or other machine capable of measuring at least 100 lbs in tensile, dynamic lap shear apparatus, 10 pounds PSA roller, and a 1″ masking tape. The materials are conditioned for a minimum of 24 hrs at standard conditions (72+/−2° F., 50+/−5% R.H.). An area 1″×2″ wide measuring from the edge of each block is taped off using the masking tape. Each block has three sample space taped off with approximately ½″ from each other. A sufficient amount of adhesive is applied at the top of the block to ensure adequate adhesive coverage of the 1″×2″ area. A trowel is positioned at approximately 75-degree angle to the block and the adhesive is slowly troweled down, using sufficient pressure on the trowel to leave the adhesive on the block in the trowel groves only. The tape is then immediately removed from the plank. The adhesive is allowed to dry for a period of 20 min at standard lab conditions (72+/−2° F., 50+/−5% R.H.). After the drying period, hardwood floor strips are applied to the adhesive and lightly pressed down by hand only to adhere to the adhesive. A 10-pound roller is then rolled back and forth on the hardwood floor (in an opposite direction of the applied adhesive) for 5 complete cycles. Three samples obtained from above are placed in standard lab conditions (72+/−2° F., 50+/−5% R.H.) for a period of 1 day or 7 days. Upon completion of the specified curing time condition, the samples are placed on Instron and pulled at 4 inches/minute using the dynamic shear apparatus. The shear strength is measured at maximum load in lbf. The shear strength and mode of failure (cohesive or adhesive failure, and general appearance) can be recorded.

Methods of using the adhesive compositions to adhere two surfaces are also disclosed. The method of adhering two surfaces can include applying the adhesive composition to at least a first surface, bringing a second surface into contact with the first surface, and allowing the adhesive composition to cure. In some embodiments, the adhesive composition can be dry to the touch in less than 4 hours, preferably less than 2 hours.

By way of non-limiting illustration, examples of certain embodiments of the present disclosure are given below.

### EXAMPLES

### Example 1: Preparation of Curable Adhesive Formulations

This example provides curable adhesive formulations comprising (a) an acrylic resin with silane functionality that is capable of moisture cure, (b) at least one type of inorganic filler, (c) adhesion promoter, (d) moisture-cure catalyst, (e) plasticizer or film-forming aid, and optionally defoamer, rheology modifier, tackifier, water scavenger. The resulting adhesives can be used to adhere floor-covering substrates, such as wood or vinyl, to subfloor structures. The compositions are free of isocyanates and do not include addition of a solvent.

The acrylic copolymer resin can be made by high-temperature radical polymerization, encompassing as a process step of co-feeding suitable monomers and catalyst. The silane-functional acrylic copolymer can be selected from (a) an acrylic copolymer derived from at least one monomer with a R₁R₂R₃Si-group, where R₁, R₂ and R₃ are independently of one another being alkoxy or alkyl, or (b) an acrylic copolymer derived from at least one acrylic ester monomer and from maleic anhydride, post-reacted with an aminosilane.

The acrylic copolymer resin can have a Brookfield viscosity of 50,000 centipoise (50 Pa s) or less such as, 30,000 centipoise (30 Pa s) or less. The curable adhesive compositions disclosed in this example can exhibit very good peel adhesions and shear values. They can exhibit high modulus and good water resistance.

Curable adhesive Sample 1: In a high speed mixer, a mixture of 177.0 g of acrylic resin modified with maleic anhydride, 60.0 g ISOPAR® M (isoparaffinic hydrocarbon solvent available from ExxonMobil®), 6.0 g vinyltrimethoxysilane, and 28.8 g 3-aminopropylmethyldiethoxysilane were mixed at high shear for 10 min to form a mixture. 71.8 g SOCAL® 312 (calcium carbonate pigment), 151.6 g HYDROCARB® PG3-FL (calcium carbonate pigment available from Omya®), 151.6 g HYDROCARB® 60-FL (calcium carbonate pigment available from Omya®), 6.0 g vinyltrimethoxysilane and 9.0 g BORCHI® KAT 24 (tin-free catalyst based on metal carboxylate available from Borchers®) were then added to the mixture, which was further agitated on high shear.

A drawdown of the resulting composition was found to be dry-to-touch after 26 min and tack-free after 5 hours.

Curable adhesive Sample 2: A second curable adhesive composition was prepared according to the above described process using the following ingredients: 185.9 g of an acrylic resin modified with organosilane functional monomer, 63.0 g ISOPAR® M, 6.3 g vinyltrimethoxysilane, and 30.2 g 3-aminopropylmethyldiethoxysilane, with subsequent addition of 75.4 g SOCAL 312, 159.2 g HYDROCARB® PG3-FL, 159.2 g HYDROCARB® 60-FL, 6.3 g vinyltrimethoxysilane and 9.5 g BORCHI® KAT 24.

### Example 2: Curable Adhesive Formulations as Flooring Adhesive

The formulations prepared in Example 1 were investigated for their use as flooring adhesives. The results at of the application tests maximum load are shown in Table 1. For each of the application tests, an average of three specimens were reported.

TABLE 1
Curable Adhesive Formulations as Flooring Adhesive

| Test | Sample 1 (lbf) | Sample 2 (lbf) | Control A (lbf) | Control B (lbf) |
|---|---|---|---|---|
| 90° Peels: Hardwood to | 130.5 | 132.6 | 108.9 | 112.7 |
| Cement Board (0.5″) - 7 Day | | | | |
| @ CTH | | | | |
| 90° Peels: Vinyl to Cement | 24.7 | 24.8 | 14.4 | 16.4 |
| Board (0.5″) - 1 Day @ CTH | | | | |
| 90° Peels: Vinyl to Cement | 23.9 | 16.6 | 22.1 | 21.5 |
| Board (0.5″) - 7 Day @ CTH | | | | |
| Lap Shears: Hardwood to | 189.4 | 153.5 | 164.1 | 92.6 |
| Cement Board (0.5″) - 1 Day | | | | |
| @ CTH | | | | |
| Lap Shears: Hardwood to | 168.2 | 200.4 | 165.3 | 193.7 |
| Cement Board (0.5″) - 7 Day | | | | |
| @ CTH | | | | |
| Lap Shears: Vinyl to Cement | 107.2 | 106.8 | 61.9 | 62.7 |
| Board (0.5″) - 1 Day @ CTH | | | | |
| Lap Shears: Vinyl to Cement | 220.3 | 311.9 | 111.9 | 117.5 |
| Board (0.5″) - 7 Day @ CTH | | | | |

Controls A and B are commercially available moisture-cure flooring adhesives derived from non-acrylic polymers.
CTH = Controlled temperature (23° C.) and relative humidity (50%).

Summary: The adhesives are moisture-curable adhesives based on silane-functional acrylic resins which are durable and can adhere to different substrates. The cure reaction is fast and does not require toxic tin-based catalysts. The curable adhesive compositions are low VOC and free of isocyanates, therefore more environmentally benign than solvent-based adhesives. The compositions are also water-free and therefore more advantageous than water-based adhesives that are prone to inflict water damage to substrates.

### Example 3: Curable Adhesive Formulations as Flooring Adhesive

Adhesive formulations according to Tables 2 and 3 were prepared and investigated for their use as flooring adhesives. Resins A and C are acrylic resins modified with maleic anhydride. Resins B, D, and E are acrylic resins modified with an organosilane functional monomer. The results of the application tests are shown in Tables 2 and 3.

TABLE 2
Curable Adhesive Formulations as Flooring Adhesive

| | | | | | | |
|---|---|---|---|---|---|---|
| Mixture number | Sample 3 | Sample 4 | Sample 5 | Sample 6 | Sample 7 | Sample 8 |

Speedmixer setting - 25° C., 10 mins @ 1,500 rpm

| | | | | | | |
|---|---|---|---|---|---|---|
| Resin A, g | 29.5 | | | | | |
| Resin B, g | | 29.5 | | | | |
| Resin C, g | | | 29.5 | 29.5 | | |
| Resin D, g | | | | | 29.5 | |
| Resin E, g | | | | | | 29.5 |
| Isopar M, g | 10 | 10 | 10 | | 10 | 10 |
| Palatinol N, g | | | | 10 | | |
| Dynasylan VTMO, g | 1 | 1 | 1 | 1 | 1 | 1 |
| Dynasylan 1505, g | 4.8 | 4.8 | 4.8 | 4.8 | 4.8 | 4.8 |

Dry filler in oven @ 120° C. for 24 hrs before usage
Speedmixer setting - 25° C., 5 mins @ 1,950 rpm (Initial: 3,000 rpm)

| | | | | | | |
|---|---|---|---|---|---|---|
| Socal 312, g | 11.97 | 11.97 | 16.95 | 16.95 | 16.95 | 16.95 |
| Hydrocarb PG3-FL, g | 25.27 | 25.27 | 35.78 | 35.78 | 35.78 | 35.78 |
| Hydrocarb 60-FL, g | 25.27 | 25.27 | 35.78 | 35.78 | 35.78 | 35.78 |

Speedmixer setting - 25° C., 5 mins @ 1,950 rpm (Initial: 3,000 rpm)

| | | | | | | |
|---|---|---|---|---|---|---|
| Dynasylan VTMO, g | 1 | 1 | 1 | 1 | 1 | 1 |
| BorchiKat 24, g | 1.5 | 1.5 | 1.5 | 1.5 | 1.5 | 1.5 |
| Total, g | 110.31 | 110.31 | 135.35 | 136.31 | 136.31 | 136.31 |
| Peel result, 1 day (wood on | 69.7 | 85.2 | 178.5 | 211.4 | 134.9 | 178.3 |
| cement), lbf | | | | | | |
| Peel result, 3 days (wood on | 70.4 | | | | | |
| cement), lbf | | | | | | |
| Peel result, 7 days (wood on | 130.5 | 132.6 | 183.1 | 186.9 | 126.1 | 145.2 |
| cement), lbf | | | | | | |
| Peel result, 1 day (vinyl on | 24.7 | 24.8 | | | | |
| cement), lbf | | | | | | |
| Peel result, 7 days (vinyl on | 23.9 | 16.1 | | | | |
| cement), lbf | | | | | | |
| Lap Shear, 1 day (wood on | 20.2 | 153.5 | 179.7 | 237.6 | 247.8 | 266 |
| cement), lbf | | | | | | |
| Lap Shear, 3 days (wood on | 20 | | | | | |
| cement), lbf | | | | | | |
| Lap Shear, 7 days (wood on | | 200.4 | 178.3 | 272.8 | 272.9 | 286.3 |
| cement), lbf | | | | | | |
| Lap Shear, 14 days (wood on | 135.4 | | | | | |
| cement), lbf | | | | | | |
| Lap Shear, 1 day (vinyl on | 107.2 | 106.8 | | | | |
| cement), lbf | | | | | | |
| Lap Shear, 7 day (vinyl on | 220.3 | 311.9 | | | | |
| cement), lbf | | | | | | |
| Brookfield Viscosity (#7 @ | | | 35520 | | 38000 | 38200 |
| 20 rpm) | | | | | | |

TABLE 3
Curable Adhesive Formulations as Flooring Adhesive

| | | | | |
|---|---|---|---|---|
| Mixture number | Sample 9 | Sample 10 | Sample 11 | Sample 12 |

Speedmixer setting - 25° C., 10 mins @ 1,500 rpm

| | | | | |
|---|---|---|---|---|
| Resin D, g | 29.5 | 29.5 | 29.5 | 29.5 |
| Palatinol N, g | 10 | 10 | 10 | 10 |
| Dynasylan VTMO, g | 1 | 1 | 1 | 1 |
| Dynasylan 1505, g | 4.8 | 4.8 | 4.8 | 4.8 |

Dry filler in oven @ 120° C. for 24 hrs before usage
Speedmixer setting - 25° C., 5 mins @ 1,950 rpm (Initial: 3,000 rpm)

| | | | | |
|---|---|---|---|---|
| Socal 312, g | 16.95 | 16.95 | 22.60 | 28.25 |
| Hydrocarb PG3-FL, g | 35.78 | 35.78 | 47.70 | 59.63 |
| Hydrocarb 60-FL, g | 35.78 | 35.78 | 47.70 | 59.63 |

Speedmixer setting - 25° C., 5 mins @ 1,950 rpm (Initial: 3,000 rpm)

| | | | | |
|---|---|---|---|---|
| Dynasylan VTMO, g | 1 | 1 | 1 | 1 |
| BorchiKat 24, g | 1.5 | 1.5 | 1.5 | 1.5 |
| Total, g | 136.31 | 136.31 | 165.80 | 195.31 |
| Peel result, 1 day | 168.3 | 197.3 | 210.4 | 181.9 |
| (wood on cement), lbf | | | | |
| Peel result, 7 day | 184.4 | 163.3 | 163.5 | 176.5 |
| (wood on cement), lbf | | | | |
| Lap Shear, 1 day | 279.6 | 204.5 | 247.8 | 308..8 |
| (wood on cement), lbf | | | | |
| Lap Shear, 7 days | 348.3 | 205.1 | 370.4 | 347 |
| (wood on cement), lbf | | | | |
| Brookfield Viscosity | 49400 | | | |
| (#7 @ 20 rpm) | | | | |

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1.-54. (canceled)

55. A composition, comprising:
a copolymer derived from one or more (meth)acrylates and one or more carboxylic acid anhydrides, the copolymer present in an amount of from 10-94.5% by weight, based on the total weight of the composition;
an inorganic filler present in an amount of at least 5% by weight, based on the total weight of the composition;
one or more aminosilanes and
a moisture cure catalyst,
wherein the composition has a solids weight % of greater than 50%, by weight of the composition.

56. The composition of claim 55, wherein the one or more aminosilanes are pendant from the copolymer backbone.

57. The composition of claim 55, wherein the one or more aminosilanes have structures represented by the general Formula I:
H₂N—(R¹)—Si(R²)₃ Formula I
wherein R¹ and R² are independently for each occurrence, selected from a C₁-C₁₀ alkyl group, a C₂-C₁₀ alkenyl group, a C₁-C₁₀ alkoxy group, a C₁-C₁₀ alkylthio group, or a C₁-C₁₀ alkylamino group.

58. The composition of claim 55, wherein the one or more aminosilanes are selected from 3-aminopropylmethyldiethoxysilane, 3-aminopropyltrimethoxysilane, 3-aminopropyltriethoxysilane, N-(2-aminoethyl-3-aminopropyl)-trimethoxysilane, or combinations thereof.

59. The composition of claim 55, wherein the composition is derived from greater than 0% to 10% by weight, of the one or more aminosilanes, based on the total weight of the composition.

60. A composition, comprising:
a copolymer derived from monomers including one or more (meth)acrylates and one or more organosilanes, wherein the copolymer is derived in the absence of a chain transfer agent at a temperature of at least 150° C., and the copolymer is present in an amount of from 10-95% by weight based on the total weight of the composition;
an inorganic filler present in an amount of at least 5% by weight, based on the total weight of the composition;
an adhesion enhancer; and
a moisture cure catalyst,
wherein the composition has a Brookfield viscosity of 10,000 cps or greater at 25° C. and 20 rpm using a #7 spindle, and a solids weight % of greater than 50%.

61. The composition of claim 60, wherein the one or more organosilanes include a vinyl silane.

62. The composition of claim 61, wherein the vinyl silane comprises vinyltrimethoxysilane, vinyltriethoxysilane, vinyl tris(2-methoxyethoxysilane), vinyl triisopropoxysilane, gamma-methacryloxypropyl trimethoxysilane, (3-methacryloxypropyl)-trimethoxysilane, (3-methacryloxypropyl)-triethoxysilane, (3-methacryloxypropyl)-triisopropoxysilane, 2-methyl-2-propenoic acid 3-[tris-(1-methylethoxy)-silyl]-propyl ester, (3-methacryloxypropyl)-methyldiethoxysilane, 3-glycidoxypropyl methyldiethoxysilane, 3-glycidoxypropyl methyldimethoxysilane, or combinations thereof.

63. The composition of claim 60, wherein the copolymer is derived from greater than 0% to 15% by weight, of the one or more organosilanes, based on the total weight of monomers in the copolymer.

64. The composition of claim 60, wherein the copolymer is derived from 60% to 95% by weight of the one or more (meth)acrylates, based on the total weight of monomers in the copolymer.

65. The composition of claim 60, wherein the copolymer has a measured T_{g} of 25° C. or less.

66. The composition of claim 60, wherein the copolymer further comprises one or more carboxylic acid monomers.

67. The composition of claim 60, wherein the adhesion enhancer comprises an aminosilane having a structure represented by the general Formula I:
H₂N—(R¹)—Si(R²)₃ Formula I
wherein R¹ and R² are independently for each occurrence, selected from a C₁-C₁₀ alkyl group, a C₂-C₁₀ alkenyl group, a C₁-C₁₀ alkoxy group, a C₁-C₁₀ alkylthio group, or a C₁-C₁₀ alkylamino group.

68. An adhesive, a sealant, a water-proofing composition, or a roof coating, including the composition according to claim 55.

69. An adhesive, including the composition according to claim 55.

70. A floor article comprising the adhesive composition according to claim 69.

71. A method of making a composition, comprising:
mixing a copolymer produced by solution polymerization and derived from one or more (meth)acrylates and one or more carboxylic acid anhydrides, the copolymer present in an amount of from 10-95% by weight, based on the total weight of the composition with one or more aminosilanes, an inorganic filler, and a moisture cure catalyst to form the composition.

72. The method of claim 71, wherein the one or more aminosilanes react such that at least a portion of the one or more aminosilanes are pendent from the copolymer backbone.

73. A method of making a composition, comprising:
mixing a copolymer produced by solution polymerization and derived from monomers including one or more (meth)acrylates and one or more organosilanes, wherein the copolymer is derived in the absence of a chain transfer agent at a temperature of at least 150° C., and the copolymer is present in an amount of from 10-95% by weight based on the total weight of the composition with an inorganic filler, an adhesion enhancer, and a moisture cure catalyst to form the composition, wherein the composition has a Brookfield viscosity of 10,000 cps or greater at 25° C. and 20 rpm using a #7 spindle, and a solids weight % of greater than 50%.

74. The method of claim 71, further comprising the step of adding a plasticizer, a stabilizer, an antioxidant, a film forming aid, or a water scavenger to the composition.
